(19) United States
(12) Patent Application Publication
(10) Pub. No.: US 2011/0066452 A1
(43) Pub. Date: Mar. 17, 2011

(54) SYSTEMS AND METHODS FOR INSURING DIGITAL MEDIA DOWNLOAD TRANSACTIONS

(75) Inventors: Neale Hall, West Yorkshire (GB); Wesley Wilcox, Addingham (GB)

(73) Assignee: ELDON TECHNOLOGY LIMITED, Keighley (GB)

(21) Appl. No.: 12/558,846

(22) Filed: Sep. 14, 2009

(51) Int. Cl. G06Q 40/00; G06Q 50/00; G06Q 30/00; G06F 3/048; G06F 15/16

(52) U.S. Cl. 705/4; 715/764; 709/217; 705/26.35

(57) ABSTRACT

Systems and methods are provided that enable a user to selectively insure purchased digital media items downloaded over a network connection. In one embodiment, a method is provided that includes the steps of receiving first user data from a user at the digital media system to request the purchase of a selected digital media item from a content provider, providing a message to the user to offer loss insurance for the selected digital media item, and receiving second user data at the digital media system to indicate whether the loss insurance offer is accepted. Acceptance data is transmitted to the content provider via the digital network to indicate whether the loss insurance offer is accepted.

### TECHNICAL FIELD

The present disclosure generally relates to systems and methods for insuring digital media download items purchased and delivered via a network.

### BACKGROUND

Digital media can now be readily purchased from content producers, content aggregators, and other content providers over a digital network and downloaded directly to a mass storage device (e.g., a hard disk drive) associated with a user's personal computer, videogame counsel, set-top box, or other local media player. Popular digital media (DM) download items include various types of video and audio content, such as albums, films, music videos, and the like, as well as software and e-books. As a distinct advantage, DM download items are delivered nearly instantaneously without the need for physical distribution of a tangible medium, such as a compact disc, digital versatile disc, audio tape, bound book, or the like. As a further advantage, a relatively large number of digital media download items can be stored on a single mass storage device thereby saving physical space and permitting the digital media items to be easily organized. However, for this same reason, an entire library of DM download items can be lost if the mass storage device fails, is destroyed (e.g., due to fire), is accidently erased, is stolen, or is otherwise placed out of a user's control. Depending upon the quantity and type of DM download items stored on the mass storage device, the cost to replace the lost download items can be considerable. Although some protection can be afforded by purchasing a separate mass storage device, such as an external hard drive disk, and frequently creating digital back-up copies of purchased DM download items, the cost of purchasing a separate mass storage device can be undesirably high and possibly prohibitive. Furthermore, even when possessing a separate mass storage device, users often fail to back-up their libraries of DM download items with sufficient frequency to prevent the loss of at least some download items should the primary mass storage device fail.

There thus exists an ongoing commercial need to provide systems and methods for permitting a user to insure against loss of digital media download items in a manner that requires minimal effort and minimal per item cost on behalf of the user. These and other desirable features and characteristics will become apparent from the subsequent Detailed Description and the appended Claims, taken in conjunction with the accompanying Drawings and this Background section.

### BRIEF SUMMARY

Embodiments of a method are provided for selectively insuring a digital media item downloaded from a content provider, over a digital network, and to a digital media download system. In one embodiment, the method includes the steps of receiving first user data from a user at the digital media system to request the purchase of a selected digital media item from a content provider, providing a message to the user to offer loss insurance for the selected digital media item, and receiving second user data at the digital media system to indicate whether the loss insurance offer is accepted. Acceptance data is transmitted to the content provider via the digital network to indicate whether the loss insurance offer is accepted.

Embodiments of a set-top box are further provided. The set-top box is configured to be operatively coupled to a display to enable a user to purchase selected digital media items downloaded from a content provider over a digital network. In one embodiment, the set-top box includes a user interface configured to receive user input data, a network interface configured to communicate over the digital network, and a controller. The controller is configured to: (i) receive user input data via the user interface to initiate the purchase of a selected digital media item from the content provider, (ii) visually express on the display a loss insurance offer for the selected digital media item, (iii) receive user input data via the user interface indicating whether the loss insurance offer has been accepted, and (iv) transmit data to the content provider over the digital network indicating whether the loss insurance offer has been accepted.

Various embodiments, aspects, and other features are described in more detail below.

### BRIEF DESCRIPTION OF THE DRAWING FIGURES

Exemplary embodiments will hereinafter be described in conjunction with the following drawing figures, wherein like numerals denote like elements, and:

FIG. 1 is a block diagram of an exemplary digital media download system configured to communicate with a content provider and an insurer over a digital network;

FIG. 2 is a flowchart illustrating an exemplary method that can be carried out by the digital media download system shown in FIG. 1, under the direction of a user, to selectively purchase insurance insuring against the accidental loss of a digital media download item; and

FIG. 3 is a data flow diagram illustrating one manner in which data may be transmitted between the digital media download system, the content provider, and the insurer shown in FIG. 1 during the performance of the exemplary method illustrated in FIG. 2.

### DETAILED DESCRIPTION

The following detailed description of the invention is merely exemplary in nature and is not intended to limit the invention or the Application and uses of the invention. Furthermore, there is no intention to be bound by any theory presented in the preceding Background or the following Detailed Description.

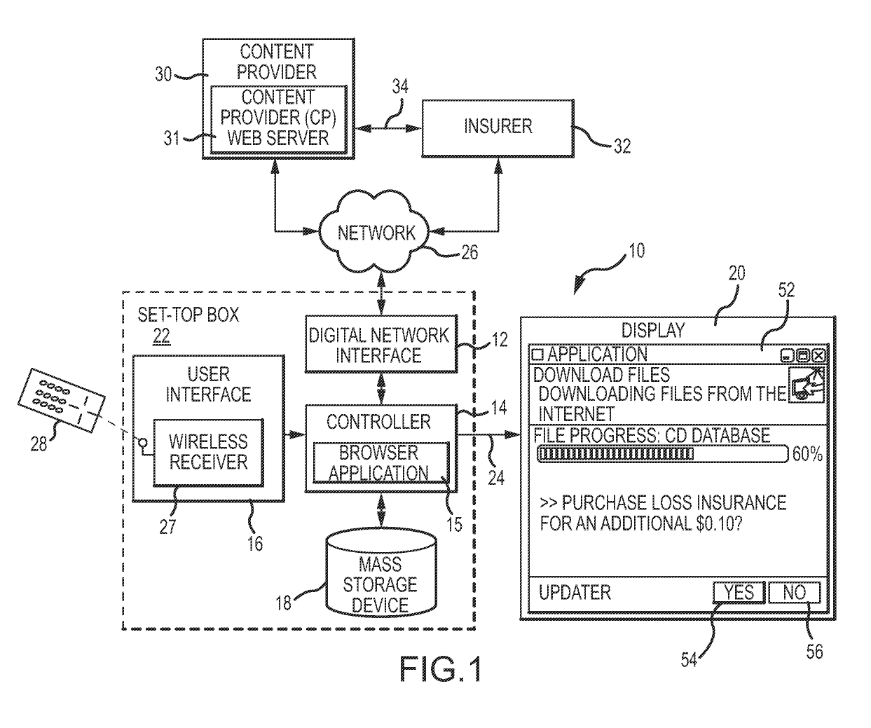

FIG. 1 is a block diagram illustrating a digital media download system 10 in accordance with an exemplary embodiment. Digital media download system 10 includes a digital network interface 12, a controller 14, a user interface 16, a mass storage device 18, and a display 20. Although not shown in FIG. 1 for clarity, digital media download system 10 will also typically include various other conventionally known hardware components and logic elements, such as temporary memory storage areas. First, second, and third outputs of controller 14 are operatively coupled to digital network interface 12, mass storage device 18, and display 20, respectively; and first, second, and third inputs of controller 14 are operatively coupled to digital network interface 12, user interface 16, and mass storage device 18, respectively. Digital media download system 10 may assume the form of a singe, free standing electronic device or multiple interconnected electronic devices. For example, digital media download system 10 may assume the form of a laptop computer, a desktop computer, a videogame console, a personal digital assistant, a mobile phone, a portable digital audio player, or other personal electronic device. In many of these implementations, mass storage device 18 and/or display 20 is integrated into a single housing with digital network interface 12, controller 14, and user interface 16. However, in certain implementations, mass storage device 18 may comprise an external storage device, such as a freestanding hard-drive disc device, connected to the other components of download system 10 utilizing one or more connector cables (e.g., a universal serial bus connector cable). Similarly, in certain embodiments, display 20 may comprise an independent image generating device, such as a freestanding monitor or television, which is connected to the other components of download system 10 utilizing appropriate connector cables.

The examples set-forth in the preceding paragraph notwithstanding, digital media download system 10 preferably comprises a set-top box (represented in FIG. 1 by dashed box 22 and referred to herein as “STB 22”) and will be described as including a set-top box herein below to provide a useful, but non-limiting, example. As indicated in FIG. 1, STB 22 contains digital network interface 12, controller 14, and/or user interface 16. Mass storage device 18 may either be internal or external to STB 22. Furthermore, as indicated above, display 20 may comprise a television or other freestanding image generating device. During operation of digital media download system 10, STB 22 provides video output signals 24 to display 20 to visually express imagery thereon, such as a graphical user interface and selected media content (e.g., video content) as described more fully below. Video output signals 24 may be formatted in accordance with any conventionally known standards including S-video, High-Definition Multimedia Interface (HDMI), Sony/Philips Display Interface Format (SPDIF), Digital Visual Interface (DVI), and IEEE 1394 standards.

Digital network interface 12 is any device, logical component, or combination thereof suitable for enabling controller 14 to send and receive packetized data over a communications network, such as digital network 26 illustrated in FIG. 1. To this end, digital network interface 12 may include transcoder logic for converting digital media content (e.g., video/audio data) into a packetized format (e.g., MPEG, QUICKTIME, WINDOWS MEDIA, and/or the like) suitable for transmission over digital network 26. Network interface 12 can operate utilizing any implementation of protocols or other features to support bi-directional communication over digital network 26. In various embodiments, network interface 12 supports the TCP/IP or UDP/IP suite of protocols widely used on the Internet.

Controller 14 can comprise any suitable number of individual microprocessors, microcontrollers, digital signal processors, programmed arrays, and other standard components known in the art. Controller 14 may also include, or otherwise be associated with, various other standard components necessary to perform the functions described herein, such as various types of memory, power supplies, interface cards, and the like. In addition to the various hardware components described above, controller 14 may include or cooperate with any number of software or firmware programs or instructions designed to carry out the various methods, process tasks, calculations, and control/display functions described below. Notably, controller 14 is configured to selectively execute a browser application 15 coded in a conventionally known browser supported language, such as HyperText Markup Language (HTML). A non-exhaustive list of commercially available applications suitable for use as browser application 15 includes the browser application marketed by Microsoft, Inc., under the trademark WINDOWS EXPLORER and made available as a component of WINDOWS operating systems; the browser application marketed by Mozilla, Inc., under the trademark FIREFOX; and the browser application marketed by Netscape Communications, Inc., under the trademark NETSCAPE NAVIGATOR.

User interface 16 can include any number of input devices suitable for receiving user input data of the type described below. In embodiments wherein digital media download system 10 assumes the form of a personal computer, a personal digital assistant, a mobile phone, or the like, user interface 16 may include a keypad (e.g., a QWERTY keyboard) and/or a cursor device (e.g., a mouse, a trackball, a touchpad, a joystick, a pointing stick, etc.). Similarly, in embodiments wherein digital media download system 10 assumes the form of a set-top box (e.g., STB 22 shown in FIG. 1), user interface 16 can include a number of physical input devices (e.g., buttons, slides, switches, dials, etc.) mounted on or through the exterior of the set-top box housing. In addition, user interface 16 may include a wireless receiver 27, such as an infrared receiver, an ultra high frequency (UHF) receiver, or the like, configured to receive wireless command signals from a remote control 28 in the well-known manner.

Mass storage device 18 can comprise various types of magnetic hard disc drives, optical hard disc drives, flash memory drives, and the like on which a user may store digital media items for subsequent playback on display 20. Notably, the digital media items stored on mass storage device 18 can be purchased via digital network 26 (e.g., by interfacing with a web server 31 associated with a content provider 30 as described more fully below) and subsequently downloaded to digital media download system 10. Such digital media items are referred to herein as “digital media download items” or, more simply, as “DM download items.” A non-exhaustive list of DM download items that may be downloaded over digital network 26 includes digital audio content of various types, such as albums, individual songs, audio books, lectures, and the like; combination audio and video content, such as full length movies, television programs, music videos, and the like; still imagery-based content, such as graphics and e-books; and computer programming and gaming content. In embodiments wherein digital media download system 10 includes a set-top box (e.g., STB 22), the DM download items conveniently include full length movies and other video content.

With continued reference to FIG. 1, digital network 26 permits bi-directional communication between digital media download system 10, a content provider 30, and possibly an insurer 32. Digital network 26 can comprise any communication network enabling the downloading of digital media items from content provider 30 to digital media download system 10 and the transmission of certain data (e.g., purchase data) from download system 10 to content provider 30 and/or to insurer 32. Digital network 26 conveniently includes one or more public or private data connections, links, or networks supporting any number of communications protocols. Network 26 will typically include the Internet or similar network based upon TCP/IP protocols. Although not shown in FIG. 1, one or more Internet servers may also be communicatively coupled to digital media download system 10. The Internet server or servers can be configured to interact with browser application 15 executing on digital media download system 10 to provide images, audio, video, and/or other content, as desired. In such embodiments, a user may direct digital media download system 10 to initially contact the Internet server and subsequently follow HTML links or other links provided by the server to contact a web server under the control of content provider 30 (e.g., CP web server 31 shown in FIG. 1). This example notwithstanding, many different interface options are available across a wide array of equivalent implementations to allow digital media download system 10 to obtain media content from content provider 30.

Although, in certain embodiments, content provider 30 and insurer 32 may be a single entity, content provider 30 and insurer 32 will typically be separate entities; for this reason, insurer 32 may be referred to as “third party insurer 32” herein. Content provider 30 can comprise any entity that makes available for purchase and download DM download items of the type described above utilizing, for example, a virtual store or website accessed utilizing a browser application, such as browser application 15. Content provider 30 may be a content producer, a content aggregator, or the like. Content provider 30 and insurer 32 may also communicate over network 26, as appropriate. Furthermore, as indicated in FIG. 1 at 34, content provider 30 may also communicate with third party insurer 32 independent of network 26 to, for example, initially structure the download insurance process described below.

It should thus be appreciated that a user may utilize digital media download system 10 (e.g., via the execution of browser application 15) to download purchased digital media items from content provider 30 and store the downloaded items on mass storage device 18. By storing the DM download items on mass storage device 18, a user can conveniently playback selected DM download items on display 20 or a similar audio and/or video playback device. However, should mass storage device 18 be rendered inoperative or unavailable (e.g., due to theft or accidental erasure), a user may lose the entire library of DM download items stored on mass storage device 18. As previously noted, the cost to replace such lost download items can be considerable, especially if many of the lost DM download items were higher priced items (e.g., downloaded movies, computer programs, videogames, etc.). Although some protection can be afforded by purchasing a separate mass storage device, such as an external hard drive disk, the cost of purchasing a separate mass storage device can be undesirably high and requires repetitive effort on behalf of the user to routinely create digital back-up copies of purchased DM download items. Therefore, the following describes an exemplary process and an exemplary implementation of digital media download system 10 that enables a user to insure against loss of each purchased DM download item with relatively little cost or effort on behalf of the user. It is believed that by enabling certain users to purchase loss insurance such users will find greater security in purchasing downloadable digital media items and, therefore, the sale of digital media items can be encouraged.

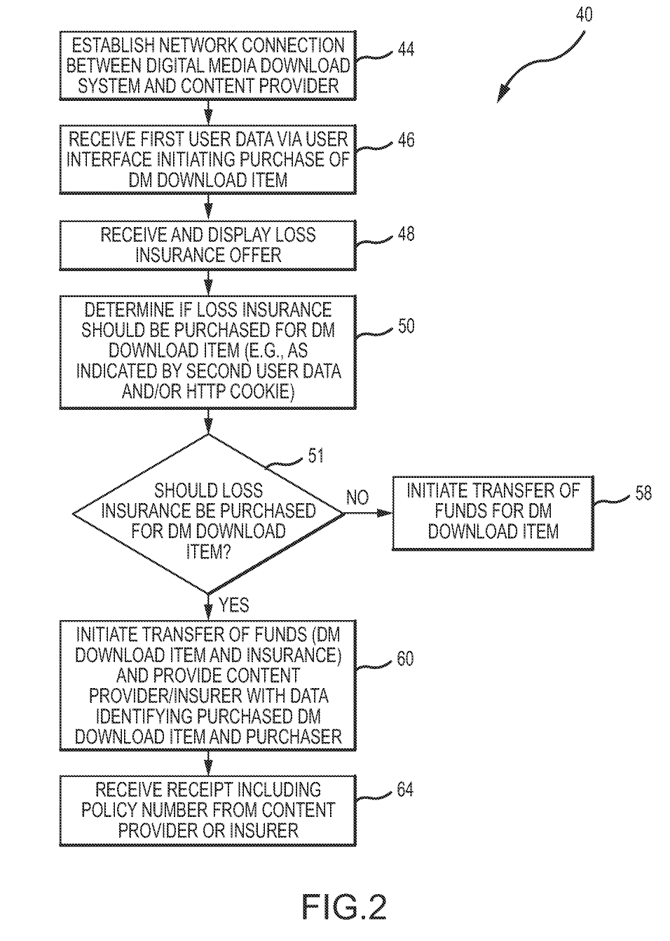

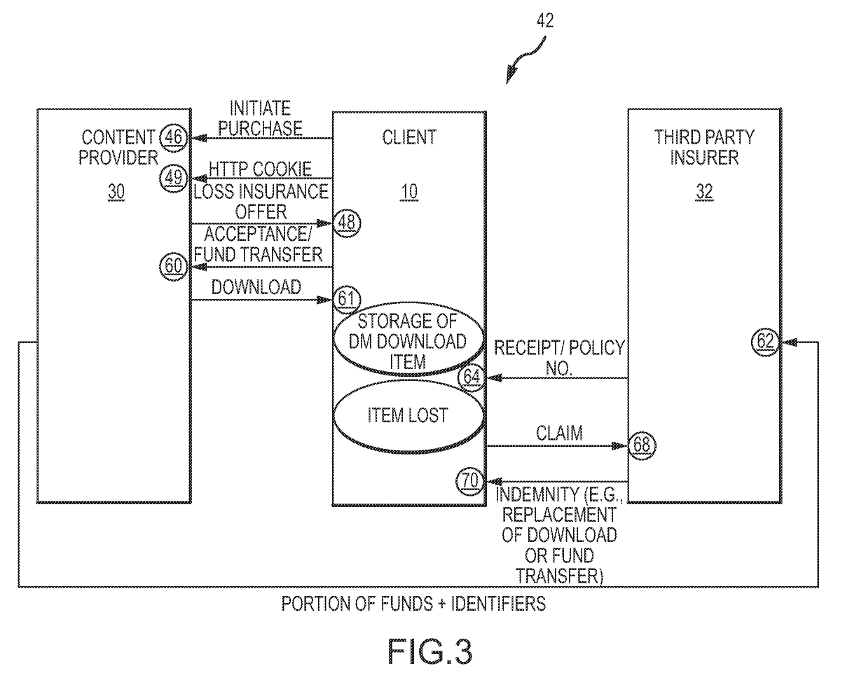

FIG. 2 is a flowchart illustrating exemplary process 40 that may be carried out by digital media download system 10, and specifically by controller 14 of STB 22, to enable a user to purchase loss insurance in conjunction with the purchase of a digital media download item; and FIG. 3 is a diagram illustrating an exemplary data flow scheme 42 involving digital media download system 10 (identified as “client 10” in FIG. 3), content provider 30, and third party insurer 32 that may occur when a user purchases loss insurance in accordance with exemplary process 40. Referring collectively to FIGS. 1-3, process 40 commences with the establishment of a connection between digital media download system 10 and content provider 30 (STEP 44, FIG. 2); e.g., a user may utilize user interface 16 (FIG. 1) to interact with web browser application 15 to direct digital media download system 10 to a website associated with content provider web server 31 in the well-known manner. After navigating through the DM download items made available on the content provider's website and locating a desired DM download item, a user next requests or otherwise initiates purchase of the selected DM download item by providing first user data via user interface 16 (STEP 46, FIGS. 2 and 3). In certain embodiments, the fund transfer and download may commence immediately. In such cases, loss insurance may be subsequently offered by content provider 30 as a related, but separate transaction. However, it is generally preferred that it is first determined whether a user wishes to purchase loss insurance covering the purchased DM download item prior to the completion of the download item transaction; in this manner, the purchase of the DM download item and the purchase of loss insurance can be combined as a single transaction.

After purchase of a selected DM download item is initiated (STEP 46, FIGS. 2 and 3), content provider 30 next indicates to the user that loss insurance can be purchased covering the DM download item (STEP 48, FIGS. 2 and 3). Content provider 30 will typically offer loss insurance, at least in part, by displaying a text message appearing on a webpage (as viewed by a user operating browser application 15) indicating that loss insurance is available for purchase and the corresponding price. The user can then utilize user interface 16 to provide second user data indicating either an acceptance or a denial of the offer (STEP 50, FIG. 2). For example, as indicated in FIG. 1 at 52, content provider 30 can provide HTML text that is visually displayed within browser application 15 in accordance with HTML tags also received from content provider 30; e.g., a text message may appear within browser application 15 stating, “PURCHASE LOSS INSURANCE FOR AN ADDITIONAL $0.10?”. A user can then utilize user interface 16 to indicate acceptance or denial of the loss insurance offer by interfacing with one or more widgets included within the content provider's webpage and rendered by browser application 15. For example, as indicated in FIG. 1 at 52, a user may select a first virtual button indicating acceptance of the offer (e.g., the “YES” virtual button illustrated in FIG. 1 at 54) or a second virtual button declining the offer (e.g., the “NO” virtual button illustrated in FIG. 1 at 56). Content provider 30 may, of course, express the offer for loss insurance in other visual and audible manners; and the user of digital media download system 10 can accept or deny the offer utilizing any pre-established means. For example, in certain embodiments, a user may indicate acceptance or denial of the loss insurance offer by pressing corresponding buttons (e.g., “YES” and “NO” buttons, “ENTER” and “CANCEL” buttons, or the like) provided on remote control 28.

It will be noted that, in the instant example, content provider 30 relates the offer of loss insurance for the purchased DM download item. Thus, in such a scenario, content provider 30 will have initially structured an agreement with third party insurer 32 regarding manner in which loss insurance should be offered, the distribution of purchased loss insurance funds, the price at which loss insurance should be offered, and so on. As will be readily appreciated, the price at which loss insurance will be offered will be chosen by the actual parties involved and will consequently vary from embodiment to embodiment. However, it is noted that the offer price of loss insurance will typically be a fraction of the price of the purchased download item. The offer price of loss insurance may be fixed (e.g., $0.10 for all purchased movies, $0.01 for all purchased digital songs, etc.) or may be determined as a percentage of the cost of the purchased DM download item (e.g., 1% total purchase price of the download item).

As indicated in FIG. 3 at STEP 49, in certain embodiments, digital media download system 10, and specifically browser application 15, can send a Hypertext Transfer Protocol (HTTP) cookie (text parcel) to content provider 30 prior to the offer of loss insurance. For example, the HTTP cookie can be sent from browser application 15 to CP web server 31 with the request for the HTM file associated with the checkout or cart page of the content provider's website (commonly referred to as a “GET” request). As will be readily appreciated, such a HTTP cookie is initially created by the server of content provider 30, transferred to digital media download system 10 in conjunction with HTML text, stored on download system 10 by browser application 15, and then returned in an unedited state each time browser application 15 accesses CP web server 31. In this manner, content provider 30 may initially establish the preferences of the user regarding loss insurances offers (referred to herein as the “loss insurance offer preference”), create an HTTP cookie noting the established user's loss insurance offer preference, and then modify the user's interactive experience during subsequent visits based upon the user's loss insurance offer preference as related by the HTTP cookie. For example, if the user's loss insurance offer preference is to automatically purchase loss insurance for DM download items by default, content provider 30 may automatically include the cost of loss insurance in a download transaction. In this case, content provider 30 may also include a widget (e.g., a virtual button) on the provider's webpage permitting a user to cancel the purchase of loss insurance and provide a corresponding text message, such as “PLEASE NOTE THAT LOSS INSURANCE HAS BEEN ADDED TO YOUR ORDER. CLICK HERE [hyperlink] TO CHANGE.” As a second example, if receiving an HTTP cookie from browser application 15 indicating that the user does not wish to purchase loss insurance as a general rule, content provider 30 may not offer loss insurance during the transaction.

If, during STEPS 50 and 51 (FIG. 2), the user declines the loss insurance purchase offer, digital media download system 10, under the direction of the user, initiates transfer of purchase funds for the DM download item (or items) to content provider 30 (STEP 58, FIG. 2). At substantially the same time as the transfer of purchase funds is initiated, content provider 30 commences download of the purchased DM download item to digital media download system 10. After the successful download of the purchased DM download item (or items) and the transfer of the purchase funds, exemplary process 40 concludes. Exemplary process 40 may then be repeated, as appropriate, for subsequent download purchases.

If, during STEPS 50 and 51 (FIG. 2), the user instead accepts the offer to purchase loss insurance, digital media download system 10, under the direction of the user, transmits acceptance data to content provider 30 and initiates transfer of purchase funds for both the DM download item and the loss insurance to content provider 30 (STEP 60, FIGS. 2 and 3). If necessary, digital media download system 10 can also provide any additional information to content provider 30 required to identify the user of download system 10 as the purchaser of the particular loss insurance policy; however, in most cases, content provider 30 will have acquired sufficient information to identify the user in the course of the purchase process (e.g., the user's name, address, and/or billing information). Downloading of purchased digital media item or item may commence at this juncture in the process (STEP 61, FIG. 3).

Next, as indicated in FIG. 3 at STEP 62, content provider 30 may transmit information identifying the user to third party insurer 32, as well as information identifying the item insured. For example, at STEP 62 (FIG. 3), content provider 30 may transmit to third party insurer 32 the user's name, address, and/or billing information, as well as a description of the item purchased and/or a unique reference number by which the download item can be identified (e.g., if the purchase DM download item is an e-book, content provider 30 may provide third party insurer with the corresponding International Standard Book Number; if the purchased DM download item is an album, content provider 30 may provide the corresponding catalog number; and so on). Content provider 30 may also initiate transfer all or a portion of the funds utilized to purchase loss insurance to third party insurer 32 at this juncture or, instead, initiate transfer of the loss insurance purchase funds at a later time. If desired, third party insurer 32 may subsequently furnish a receipt (e.g., via email) to the user of digital media download system 10 indicating that loss insurance was purchased and providing a policy number for future reference (STEP 64, FIGS. 2 and 3).

The user of digital media download system 10, now a loss insurance policy holder, can seek indemnification should the insured DM download item be accidentally lost; e.g., due to destruction, theft, failure, or the like of mass storage device 18. After such loss, the user may make a claim directly to third party insurer 32 (STEP 68, FIG. 3) by contacting third party insurer 32 in some predetermined manner, such as by telephone, by email, by a real-time web interface, or the like. Upon verification of the validity of the claim by reference to the previously-stored information identifying the user, the insured download item, and/or the policy number, the third party insurer 32 may indemnify the user against the insured loss (STEP 70, FIG. 3). For example, third party insurer 32 may provide the user with a replacement digital media download item either directly or indirectly (e.g., by instructing content provider 30 to refurnish the lost download item). Alternatively, third party insurer 32 may initiate the transfer of funds to the user sufficient to reacquire the lost digital media item. In this latter scenario, if third party insurer 32 previously stored credit card or debit card information utilized to purchase the loss insurance, third party insurer 32 may simply credit the appropriate amount back to the user's account.

There has thus been provided embodiments of a digital media download system and process enabling a user to selectively insure against the accidental loss of a purchased digital media download item. In many embodiments, minimal effort and per-item cost is required on behalf of the user to purchase the loss insurance using the above-described system and process, especially as compared to the relatively cumbersome process of purchasing and continually creating back-up copies of a digital media library utilizing an auxiliary volume storage device. By providing optional loss insurance in this manner, consumer confidence can be increased, which, in turn, may promote the sale of digital media download items. Steps may be omitted, reordered, and/or added to the above-described exemplary loss insurance process in alternative embodiments, without departed from the scope of invention as set-forth in the subsequent Claims.

Various exemplary processes and system have thus been described that enable a user to purchase loss insurance covering a digital media item download from a content provider. As utilized herein, the word “exemplary” means “serving as an example, instance, or illustration.” Any implementation described herein as exemplary is not necessarily to be construed as preferred or advantageous over other implementations. While at least one exemplary embodiment has been presented in the foregoing Detailed Description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the Claims and their legal equivalents.

What is claimed is:

1. A method for selectively insuring a digital media item downloaded from a content provider, over a digital network, and to a digital media system, the method comprising:
receiving first user data from a user at the digital media system to request the purchase of a selected digital media item from a content provider;
providing a message to the user to offer loss insurance for the selected digital media item;
receiving second user data at the digital media system to indicate whether the loss insurance offer is accepted; and
transmitting acceptance data to the content provider via the digital network to indicate whether the loss insurance offer is accepted.

2. A method according to claim 1 wherein the loss insurance offer is made by the content provider on behalf of a third party insurer, and wherein the method further includes providing data to the third party insurer to identify the selected digital media item and the user of the digital media download system.

3. A method according to claim 2 wherein the providing data comprises transmitting data from the digital media download system to the third party insurer to identify the selected digital media item and the user of the digital media download system after acceptance of the loss insurance offer.

4. A method according to claim 2 further comprising receiving at the digital media download system a receipt generated by the third party insurer and including a loss insurance policy number.

5. A method according to claim 1 wherein the digital media download system comprises a set-top box including a wireless receiver configured to receive command signals from a remote control, and wherein the receiving comprises receiving user input data via the remote control to initiate the purchase of a selected digital media item from the content provider.

6. A method according to claim 5 wherein the set-top box further comprises a mass storage device, wherein the selected digital media item comprises video content, and wherein the method further includes storing the video content in the mass storage device.

7. A method according to claim 1 wherein the digital media download system is configured to execute a browser application, and wherein the method further comprises:
receiving via the browser application a Hypertext Transfer Protocol (HTTP) cookie generated by the content provider and describing a preference of the user of the digital media download system pertaining to loss insurance offers; and
storing the HTTP cookie on the digital media download system.

8. A method according to claim 7 further comprising providing, via the browser application, the HTTP cookie to the content provider after establishing a network connection between the digital media download system and the content provider.

9. A digital media download system to enable a user to purchase a selected digital media item from a content provider over a digital network, the digital media download system comprising:
a first interface configured to receive user data;
a controller configured to receive the user data via the first interface, wherein the user data indicates whether the user desires to purchase loss insurance for the selected digital media item; and
a second interface configured to transmit the acceptance data to the content provider over the digital network.

10. A digital media download system according to claim 9 further comprising a display operatively coupled to the controller, and wherein controller is further configured to: (i) receive data from the content provider indicating that loss insurance is offered for the selected digital media item, (ii) visually express the loss insurance offer on the display, and (iii) transmit data to the content provider indicating whether the loss insurance offer has been accepted.

11. A digital media download system according to claim 10 further comprising a set-top box operatively coupled to the display and including the controller.

12. A digital media download system according to claim 11 wherein set-top box is configured to be utilized in conjunction with a remote control, and wherein the user interface comprises a wireless receiver disposed in the set-top box and operatively coupled to the controller.

13. A digital media download system according to claim 12 wherein the controller is configured to receive user data via the wireless receiver indicating whether the loss insurance offer has been accepted.

14. A digital media download system according to claim 9 further comprising a browser application executable by the controller, wherein the controller is further configured to transmit data to the content provider indicating a user preference pertaining to loss insurance offers, and wherein the browser application is configured to receive and store a Hypertext Transfer Protocol (HTTP) cookie created by the content provider and indicative of the user preference.

15. A digital media download system according to claim 14 wherein the HTTP cookie indicates whether loss insurance should be offered to the user of the digital media download system.

16. A digital media download system according to claim 10 wherein the loss insurance offer is provided by the content provider on behalf of a third party insurer, and wherein the controller is further configured to transmit data to the third party insurer identifying the selected digital media item and the user of the digital media download system.

17. A set-top box configured to be operatively coupled to a display to enable a user to purchase selected digital media items downloaded from a content provider over a digital network, the set-top box comprising:
a user interface configured to receive user input data;
a network interface configured to communicate over the digital network; and
a controller configured to: (i) receive user input data via the user interface to initiate the purchase of a selected digital media item from the content provider, (ii) visually express on the display a loss insurance offer for the selected digital media item, (iii) receive user input data via the user interface indicating whether the loss insurance offer has been accepted, and (iv) transmit data to the content provider over the digital network indicating whether the loss insurance offer has been accepted.

18. A set-top box according to claim 17 wherein the set-top box is configured to be utilized in conjunction with a remote control, and wherein the user interface comprises a wireless receiver disposed in the set-top box and operatively coupled to the controller.

19. A set-top box according to claim 18 wherein the controller is configured to receive user data provided via the remote control and received via the wireless receiver indicating whether the loss insurance offer has been accepted.

20. A set-top box according to claim 17 further comprising a browser application executable by the controller and configured to provide a Hypertext Transfer Protocol (HTTP) cookie to the content provider indicative of a previously-established loss insurance offer preference prior to transmitting data to the content provider over the digital network indicating whether the loss insurance offer has been accepted.
